(19) United States
(12) Patent Application Publication
(10) Pub. No.: US 2005/0254849 A1
(43) Pub. Date: Nov. 17, 2005

(54) Image forming apparatus

(75) Inventor: Mikimasa Honma, Saitama (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Business Technologies, Inc., Tokyo (JP)

(21) Appl. No.: 10/993,635

(22) Filed: Nov. 19, 2004

(30) Foreign Application Priority Data
May 11, 2004 (JP) JP2004-141032

(51) Int. Cl. G03G 15/00; G03G 21/00

(52) U.S. Cl. 399/80; 399/124

(57) ABSTRACT

Disclosed is an image forming apparatus comprising: a door for allowing a user to access to a sheet path of the image forming apparatus to recover from a sheet jam; a lock for locking the door; an input unit for inputting information about a user; and a controller for controlling the lock to unlock the door in a case where the information about the user is recognized.

### CROSS-REFERENCE TO RELATED APPLICATION

This application is based on Japanese Patent Application No. JP2004-141032 filed with Japan Patent Office on May 11, 2004, the entire content of which is hereby incorporated by reference.

### BACKGROUND OF THE INVENTION

1. Field of the Invention

The present invention relates to an image forming apparatus by which the image formation of a secret document is conducted.

2. Description of the Related Art

Conventionally, for a purpose of securing a security of the document, an operator to use a copier is limited by certifying him. Further, when an image is outputted based on the image data stored in the copier, a technology by which the operator is made accessible to the image data by certifying him, and the data is made unable to be freely outputted without the certification, is widely known.

Further, in Japanese Un-published Patent Publication (Tokkai) No. 2000-187419, a technology by which certifying information of a person to conduct copying is written on the read image data as the watermarked information, and synthesized and stored, and when it is outputted, the image data in which the watermarked data is synthesized, is printed on a transfer sheet, is instructed. Hereby, the control for the leakage of a secret document is conducted.

Further, ordinarily, because a copier is used by a plurality of users, there is a case where a printed document is looked by unspecified another user. Accordingly, there is a copier which is made so that a door for taking-out provided on tray is opened by the certifying, and the document is not looked by the unspecified other user (for example, refer to Tokkai No. 2001-265739, Tokkaihei No. 07-247047).

When, by sheet jam, the printed transfer sheet is in the conveying path, it is necessary that a door for sheet jam processing is opened and jammed sheet is removed. A case where the user himself who uses the copier, conducts the sheet jam processing, and can take out the jammed sheet, is good, however, when he can not conduct the processing, he entrusts the processing to an operator of the third person, and the document is looked by the third person. Further, in the operation other than the jammed sheet processing, the third person can look furtively the printed transfer sheet from the conveying path.

### SUMMARY OF THE INVENTION

In view of the above conditions, the present invention is attained, and an object of the present invention is to provide a novel image forming apparatus by which the document security can be secured.

Another object of the present invention is to provide a novel image forming apparatus by which the document leakage following the sheet jam processing can be prevented.

To achieve at least one of the above mentioned objects, an image forming apparatus reflecting a first aspect of the invention comprises: a door for allowing a user to access to a sheet path of the image forming apparatus to recover from a sheet jam; a lock for locking the door; an input unit for inputting information about a user; and a controller for controlling the lock to unlock the door in a case where the information about the user is recognized.

According to an image forming apparatus reflecting a second aspect of the invention comprises: a door for allowing a user to access a sheet path of the image forming apparatus to recover from a sheet jam; a lock for locking the door; a controller for locking the door while the image forming apparatus is set in a first mode, and for unlocking the door while the image forming apparatus is set in a second mode.

The image forming apparatus reflecting the second aspect preferably comprises an input unit for inputting information about the user. In this case, in the first mode, the controller preferably controls the lock to unlock the door in a case where the information about the user is recognized.

According to an image forming apparatus reflecting a third aspect of present invention comprises: a door for allowing a user to access a sheet path of the image forming apparatus to recover from a sheet jam; a lock for locking the door; an input unit for inputting information about a user; and a controller for controlling the lock to lock the door unless the information about the user is recognized.

The image forming apparatus reflecting the third aspect is preferably capable of being selectively set in a first mode and a second mode. In this case, in the first mode, the controller preferably controls the lock to lock the door unless the information about the user is recognized. In addition, in the second mode, the controller preferably controls the lock to unlock the door regardless of the recognition of the information about the user.

According to a fourth aspect of the present invention, an image forming apparatus comprises: a first door for allowing a user to access to a sheet on which an image has been or is being formed, a sensor for sensing a sheet jam; a lock for locking the door; an input unit for inputting information about a user; and a controller for controlling the first lock to unlock the door in a case where the sheet jam is detected by the sensor and the information about the user is recognized.

According to a fifth aspect of the present invention, an image forming apparatus comprises: a first door for allowing a user to access to a sheet on which an image has been or is being formed; a sensor for sensing a sheet jam; a lock for locking the door; an input unit for inputting information about a user; and a controller, when the sheet jam has been detected by the sensor, for controlling the first lock to lock the door unless the information about the user is recognized.

In any case, the information about the user preferably comprises at least one of living body information such as fingerprint (including thumb) information, vocal band information, iris information and so on, a password, and information recorded on an IC card.

### BRIEF DESCRIPTION OF DRAWINGS

These and other objects, advantages and features of the invention will become apparent from the following description thereof taken in conjunction with the accompanying drawing in which:

FIG. 1 is a perspective view showing an external appearance of a copier of an embodiment according to the present invention;

FIG. 2 is a perspective view showing a condition under which a removal door 401 of the copier of FIG. 1 is opened;

FIG. 3 is a sectional view showing an outline mechanical structure of the copier of FIG. 1;

FIG. 4 is a block diagram showing a control structure of the copier of FIG. 1;

FIG. 5 is a flow chart showing an example of procedures of printing job execution and jam processing;

FIG. 6 is a flow chart showing an example of procedures of printing job execution and jam processing;

FIG. 7 is a flow chart showing an example of procedures of printing job execution and jam processing;

FIG. 8 is a view showing an example of an image plane displayed on an operation display section;

FIG. 9 is a view showing an example of an image plane displayed on an operation display section; and

FIG. 10 is a view showing an example of an image plane displayed on an operation display section.

### DETAILED DESCRIPTION OF THE PREFERRED EMBODIMENTS

Referring to a view of an image forming apparatus of embodiments of the present invention, the present invention will be described below. Note that the present invention is not limited to the embodiments described below. Definitions of terms described below are given by way of explanation of the terms only, and thus the definitions of the terms of the invention are not limited thereto.

(External Appearance)

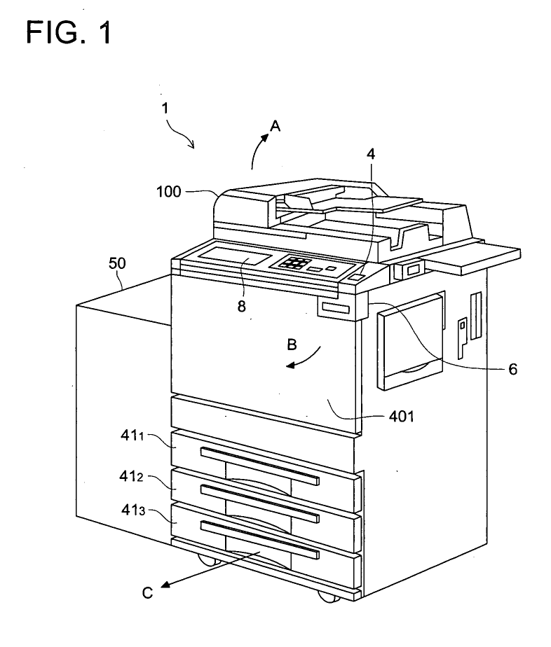

FIG. 1 is a perspective view showing an external appearance of a copier 1 as an image forming apparatus to which an embodiment of the present invention is applied. The copier 1 is provided with, on its upper portion, an automatic double sided document conveying section (RADF) 100, by which a plurality of documents can be successively and automatically fed to a reading section. This automatic double sided document conveying section 100 is rotatably provided around its depth side to a main body, and this side can be lifted in A direction of an arrow mark. When the automatic double sided document conveying section 100 is lifted, an operator can place a document surface of document S (a surface on which an image is formed) so that the document surface faces a platen glass (document glass) 11 surface, which will be described later, and the copier 1 can also read an image of the document S under this condition.

Further, the copier 1 is provided with an operation display section 8 to conduct each kind of input, and a fingerprint reading section 4 for reading a fingerprint on this side of its upper portion. Further, on lower side of the fingerprint reading section 4, an IC card drive 6 for inserting an IC card and for conducting reading and writing the information is provided.

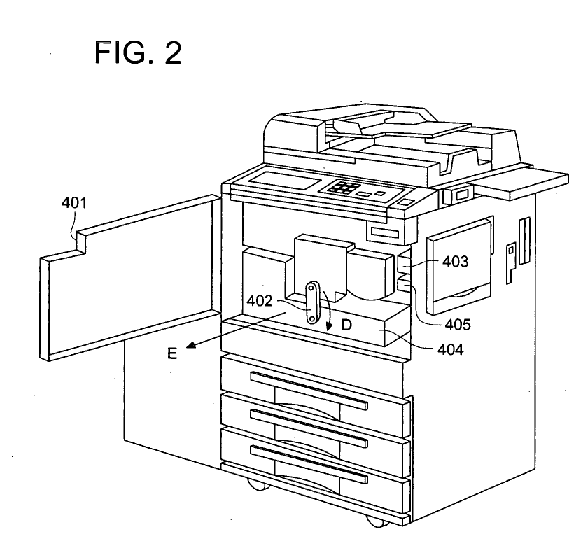

The copier 1 is provided with a jam removal door 401 for sheet jam processing on the upper side of its front surface, and can pull the right side of the door in the B direction of an arrow mark and open the door around the left side (refer to FIG. 2 which will be described later).

Further, on the lower side of the front surface, a sheet feed cassette 41 (in the view, 3 stages of 41₁, 41₂, 41₃) is provided. Each sheet feed cassette 41 can be pulled out in C direction of an arrow mark for supplement of transfer sheets P. Hereupon, in the present embodiment, “a transfer sheet” corresponds to other than an ordinary paper, a sheet including an OHP. On the left side of the copier 1, a transfer sheet delivery sheet section 50 is provided. A detail of this transfer sheet delivery sheet section 50 will be described later.

(An Inside of a Jam Removal Door)

FIG. 2 is a perspective view showing a condition under which a jam removal door 401 of a copier 1 of FIG. 1 is opened, and referring to this view, a jam removal will be described. As shown in FIG. 2, when the jam removal door 401 is opened, a jam removal lever 402, a jam removal door lock member 403, and a jam removal door open-close sensor 405 are provided. The jam removal lever 402 is a lever for pulling out a conveying unit 404 in E direction of an arrow mark, and in the case where a sheet jam is generated, when the lever is tilled in D direction of an arrow mark, the conveying unit 404 can be pulled out. Hereby, the operator can remove a transfer sheet P in a conveying path of the pulled-out conveying unit. However, the jam removal door 401 can be opened when a lock of the jam removal door lock member 403 is released. A control of this jam removal door lock member 403 will be described later.

(Structure)

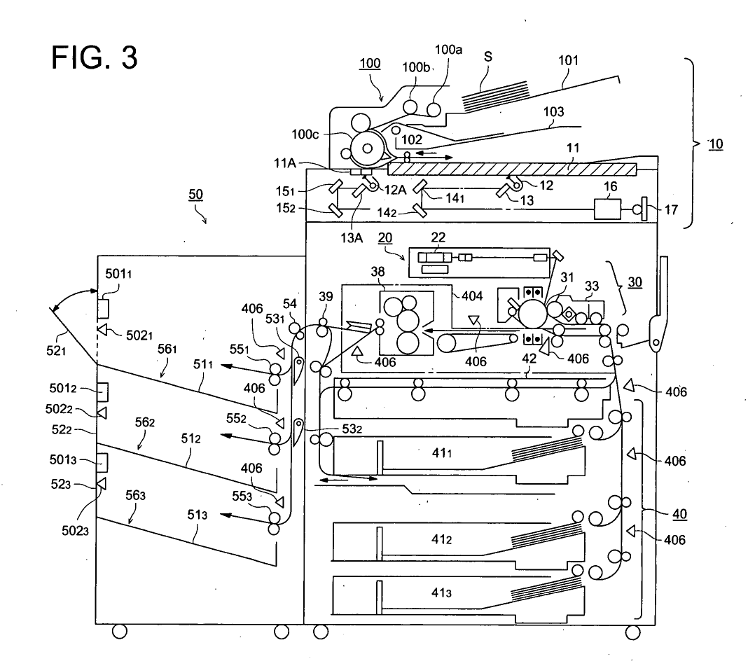

FIG. 3 is a sectional view showing an outline mechanical structure of the copier 1. In FIG. 3, the copier 1 comprises including an image reading section 10, image writing section 20, image forming section 30, transfer sheet conveying section 40 and transfer sheet delivery sheet section 50.

The image reading section 10 is provided with a platen glass (document glass) 11, scanning light source 12 such as a halogen lamp, mirrors 13, 14₁, 14₂, lens 16, CCD imaging device 17. On the platen glass (document glass) 11, the document S is placed so that its image surface faces the upper surface of the platen glass, and the light is projected by the scanning light source 12 from the lower surface of the platen. The light is reflected on the document surface, reflected by mirrors 13, 14₁, 14₂, and through the lens 16, reaches the CCD imaging device 17, and herein, is converted into an electric signal (document image data). Further, the image reading section 10 is provided with, as shown in FIG. 1, an automatic double sided document conveying section (RADF) 100, and thereby, contents of a plurality of document sheets S fed from a document placement table 101 can be successively and automatically read.

The image writing section 20 is provided with a semiconductor laser 22. The semiconductor laser 22 is modulated based on the image data, and the modulated laser light is main-scanning deflected by a polygonal mirror. The main-scanning deflected laser light reaches, through an fθ lens and a returning mirror, a photoreceptor drum 31. Hereupon, as the image data for modulating the semiconductor laser 22, an electric signal (scanning image data) sent from the CCD imaging device 17, electric signal (received image data) for the document surface received by the facsimile function, and further, the image data sent from a personal computer connected to the present copier 1, are listed.

The image forming section 30 provides with a developing section 33 in addition to the photoreceptor drum 31. When the uniformly charged photoreceptor drum 31 receives the exposure by the laser light while rotating clockwise, an electrostatic latent image is formed on its surface. Then, when the photoreceptor drum 31 is further rotated, the electrostatic latent image is visualized by toner particles in the developing section 33, and after that, the toner image is transferred onto a transfer sheet P conveyed from the transfer sheet conveying section 40. After this, the transfer sheet P passes a fixing section 38 through a conveying path, and the fixing of the transferred toner particles is conducted, and is conveyed to the transfer sheet delivery sheet section 50 by a roller 39.

The transfer sheet conveying section 40 feeds the transfer sheet P from the sheet feed cassette 41 (in FIG. 3, 3 stages of 41₁, 41₂, 41₃), and in timed relationship with the toner image on the photoreceptor drum 31, conveys the transfer sheet P to the transfer section. Further, when the above-described transfer of the toner image from the photoreceptor drum 31 onto the transfer sheet P is conducted onto not only one surface of the transfer sheet P, but onto also the other surface, the transfer sheet P on which a single side copy is completed, is conveyed to a transfer sheet reversal section 42, reversed, and conveyed again to the transfer section, and the toner image is transferred onto another surface different from the previously transferred surface, and the transfer sheet P is conveyed to the fixing section and the transfer sheet delivery sheet section 50. Herein, the transfer sheet onto which the toner image is transferred can be said as a document in which an image is formed on the transfer sheet. Further, in the conveying path of the transfer sheet P, jam sensors 406 for detecting the sheet jam are respectively provided, for example, between the photoreceptor drum 31 and the sheet feed cassette 41, between the photoreceptor drum 31 and the fixing section 38, and between the fixing section 38 and rollers 39. Further, the conveying unit 404 described in FIG. 2, comprises including, for example, the fixing section 38, rollers constituting the conveying path or a conveying guide in a range enclosed by a one dotted chain line in FIG. 3.

The transfer sheet delivery sheet section 50 provides with a confidential tray 51 (in FIG. 3, 3 of 51₁, 51₂, 51₃), roller 54, switch gate 53 (in FIG. 3, 2 of 53₁, 53₂), rollers 55 (in FIG. 3, 3 of 55₁, 55₂, 55₃), and take-out door 52 (in FIG. 3, 3 of 52₁, 52₂, 52₃). The transfer sheet delivery sheet section 50 initially, conveys the transfer sheet P by the roller 54, switches the conveying path by the switch gate 53, and when the roller 55 is selectively driven, the transfer sheet P is delivered to any one of the confidential sheet delivery trays 51. In the vicinity of respective rollers 52₁, 52₂, 52₃, jam sensors 406 for detecting the sheet jam are provided. Further, respective take-out doors 52 (in FIG. 3, 3 of 52₁, 52₂, 52₃) for taking out the transfer sheets P (image formed documents) accommodated in respective confidential delivery sheet trays are provided. Further, each of take-out doors 52 can be opened when a lock of each of take-out door lock members 501 is released. Further, take-out door open-close sensors 502 for detecting a condition in which the take-out door 52 is opened or closed, are provided. The control of this take-out door lock member 501 will be described later. A confidential box 56 (in FIG. 3, 3 of 56₁, 56₂, 56₃) is comprised including this confidential delivery sheet tray 51 and the take-out door 52. Hereinafter, there is a case where the sheet delivery to the confidential delivery sheet tray 51 is said as the sheet delivery to the confidential box. Further, when the transfer sheet is jammed under the condition that the transfer sheet is nipped by the rollers 55, there is also a case where the take-out door 52 is opened and the jam is removed.

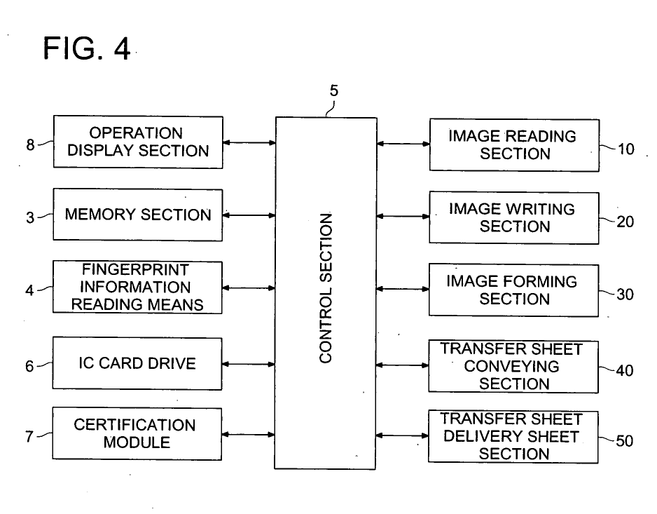

Next, FIG. 4 is a block diagram showing an electric apparatus structure of the copier 1 of the present embodiment. The copier 1 of the present embodiment is a copier by which a printing job is conducted based on a printing job data, and electrically, as shown in FIG. 4, it comprises an image reading section 10, image writing section 20, image forming section 30, transfer sheet conveying section 40, transfer sheet delivery sheet section 50, operation display section 8, memory section 3, fingerprint information reading section 4, IC card reading section 6, certifying module 7, and control section 5.

Herein, a printing job data means an image data of 1 unit composed of the image data and the set data. The image data includes the above described scanning image data, received image data, image data sent from PCs, and the set data includes operation environmental conditions necessary for driving the copier 1 for the purpose of conducting the image formation relating to the image data. Specifically, the set data includes the distinction information relating to a size such as A4/B5 concerning to the document S or transfer sheet P, similarly, the distinction information relating to a plain paper/carton/thin paper (classification), and the information relating to the magnification of the image or image density when the image is formed on the transfer sheet P. Further, “to conduct the image formation based on the printing job data” is said as “to conduct the printing job”.

As a specific structure, the operation display section 8 is allowable when a well-known LCD touch panel in which, for example, a touch panel for receiving the operation and an LCD as a display for displaying a pattern or a character, are arranged in superimposition, is adopted. This LCD touch panel has a function as the input section by which each kind of input and an operation can be conducted through the touch panel by pressing a position of an image displayed on LCD. For example, the user can input a selection of the image formation mode which will be described later, the set data of the printing job such as the copying density or magnification, or the information relating to a controller or the user.

The fingerprint information reading section 4 has a window for pressing the finger on it, and the light is irradiated on the pressed finger, it receives the reflection light from the finger through the window, and reads the fingerprint information of the pressed finger based on the received light. Hereupon, herein, the finger is a conception including the thumb. The fingerprint information reading section 4 conducts the personal certification when the fingerprint as the living body information of the user is read. Hereupon, in replace with the fingerprint information reading section 4, or in addition to it, an information reading section by which the another living body information, for example, the voice information or iris information is read, can also be adopted.

The IC card drive 6 has an insertion opening for inserting an IC card, and reads the information written in the inserted IC card, or writes the information in it.

The memory section 3 stores the printing job data, or the certifying information of a controller or the user.

The certifying module 7 certifies when a password inputted from the operation display section 8 and/or the certifying information such as the fingerprint information from the fingerprint information reading section 4 is compared to the certifying information stored in the memory section 3.

The transfer sheet conveying section 40 includes the jam removal door lock member 403, jam removal door open-close sensor 405, and jam sensor 406. The jam removal door lock member 403 has, for example, an electromagnetic solenoid, and when it is a lock member in which the electromagnetic solenoid is controlled by an electric signal, and a lock operation or a lock release operation is switched, it may be allowed. Further, when the lock operation is conducted, the jam removal door 401 is made so that the door can not be opened, and when the lock release operation is conducted, the jam removal door 401 can be made so that the door can be opened and closed. Further, the jam removal door open-close sensor 405 is a sensor attached to the door so that the output is changed following the open and close of the jam removal door 401, for example, a micro switch. Further, the jam sensor 406 may be a photo sensor to detect the existence of the transfer sheet P, and the like.

The transfer sheet delivery sheet section 50 includes, as described above, a take-out door lock member 501, take-out door open-close sensor 502 and jam sensor 406. The take-out door lock member 501 is the similar to the jam removal door lock member 403, and when the lock operation is conducted, the take-out door 52 is made so that the door can not be opened, and when the lock release operation is conducted, the take-out door 52 is made so that the door can be opened and closed. Further, the take-out door open-close sensor 502 is a sensor attached to the door so that the output is changed following the open and close of the take-out door 52, for example, a micro switch. Further, the jam sensor 406 may be a photo sensor or the like, to detect the existence of the transfer sheet P.

The control section 5 controls each of sections of the copier 1 based on the program stored in a system memory which will be described later. Further, the control section 5 has a function for setting the image formation mode when it receives the input of selection of image formation mode on the operation display section 8, and a function by which the jam removal door lock member 403 and the take-out door lock member 501 are controlled and the lock operation or the lock release operation of the jam removal door 401 and the take-out door 52 are controlled. Therefore, it comprises including a CPU (not shown) and each kind of program such as control program of the entire apparatus and each kind of data necessary when the program is conducted, are stored, and a system memory (not shown) for structuring a work area when each kind of program is conducted.

Herein, an example of a controller and user registration will be described.

(Administrator Registration)

The administrator registration is conducted to each of copiers 1. Initially, the operation display section 8 is operated and an administrator registration image plane 201 is displayed. By using the administrator registration image plane 201, an administrator ID, E-mail address, password as the certifying information are inputted, a registration start key 202 is pressed, and the registration is started. For example, according to the successively displayed image plane or instruction, when the fingerprint information is used as the certifying information, the fingerprint of the administrator is read in the fingerprint reading section 4, and the fingerprint information is inputted, alternatively, when the certification is conducted by using the IC card, the registration is conducted in such a manner that the IC card is inserted into a card drive 6, and the information for the certification is written in the IC card. Then, each registered information of the administrator is stored in the memory section 3.

(User Registration)

The user conducts the user registration for each of copiers. The user registration is conducted under the permission of administrators of each of copiers. For example, when the user registration is conducted for the copier 1, initially, the certification of the administrator of the copier 1 is conducted. The certification is conducted in such a manner that the certification information such as the password or IC card is inputted, and the inputted certification information is compared to the certification information stored in a server 2. After the certification is conducted, the operation display section 8 is operated, and a user registration image plane 211 as shown in FIG. 9, is displayed. By using the user registration image plane 211, the user ID, E-mail address, password as the certification information are inputted, and when the registration start key 212 is pressed, the registration is started. For example, following the successively displayed image plane or instructions, when the fingerprint information is used as the certification information, the fingerprint of the administrator is read by the fingerprint reading section 4, and the fingerprint information is inputted, further, when the certification is conducted by using the IC card, the registration is conducted in such a manner that the IC card is inserted into the IC card drive 6, and the information for the certification is written in the IC card. Then, each registered user information is stored in the memory section 3.

(Jam Removal Permission)

In the present embodiment, further, the administrator classifies the registered users into the jam removal permission user or the jam removal no-permission user. When a classification of users is conducted, as an example, initially, the certification of the administrator of the copier 1 is conducted, and after the certification is conducted, the operation display section 8 is operated, and a user classification image plane 221 as shown in FIG. 10, is displayed. In the no-permission user display column 222 and the permission user display column 223, the jam removal no-permission user and the jam removal permission user are respectively displayed. The users are classified in such a manner that, in the no-permission user display column 222 and the permission user display column 223, scroll keys 224, 225 are respectively displayed, and by the scroll keys 224 and 225, the display of the user is moved, and the objective user is pressed and selected, and by an arrow mark key 226 or 227, it is moved to the no-permission user display column 222 or the permission user display column 223, and registered by a registration key 228, and the permission of jam removal is given to the specific user.

(Execution of Printing Job and Jam Processing)

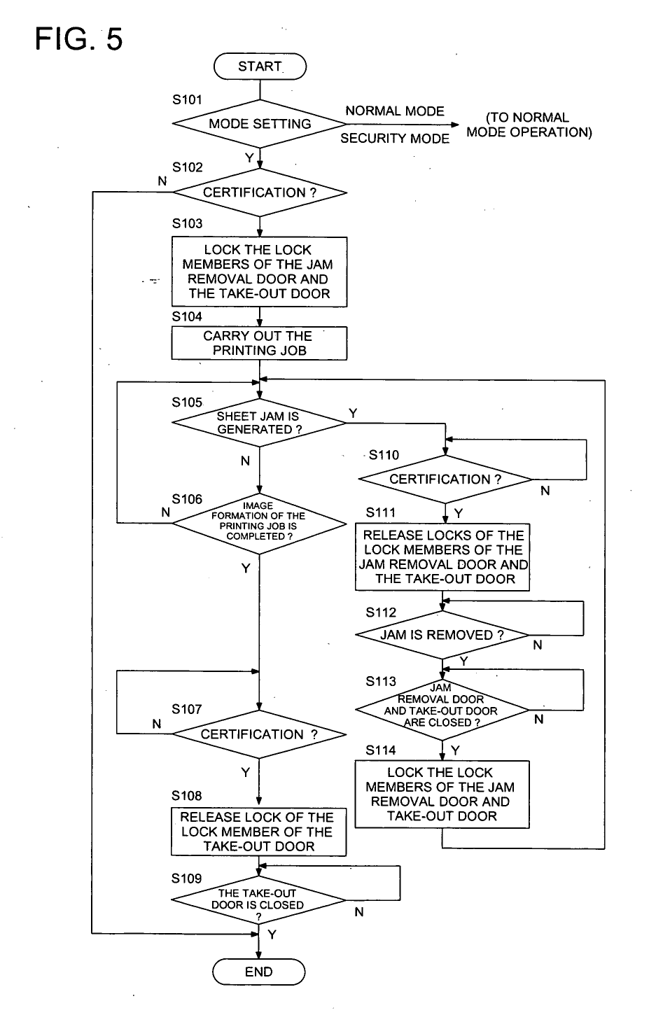

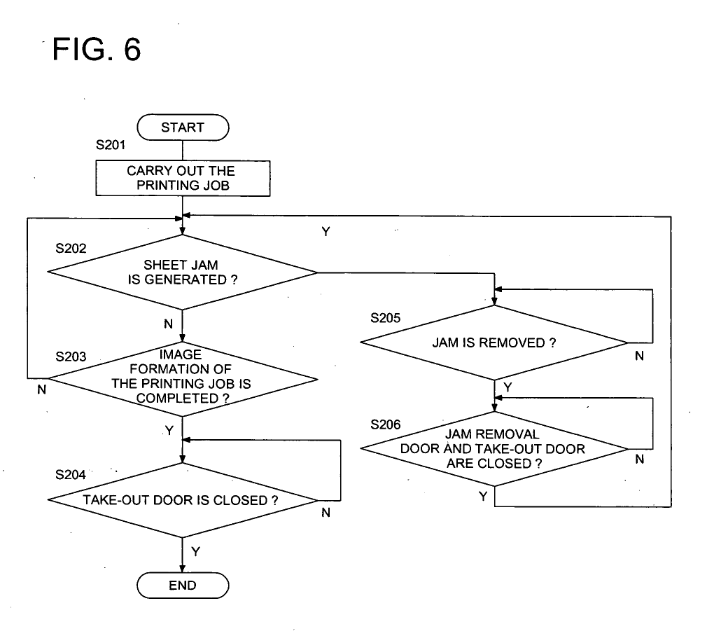

Next, by using FIGS. 5 and 6, a procedure of the execution of the printing job and the jam processing will be described. FIGS. 5 and 6 are flowcharts showing an example of a procedure of the printing job execution and the jam processing. The printing job execution in each image forming mode and the jam processing will be described below, however, it will be described on the assumption that, in the present embodiment, at the start time, the jam removal door is closed, and the lock of the jam removal door lock member 403 is released, the take-out door 52 is closed, and the lock of the take-out door lock member 501 is released. Further, although it is not detailed, it may be structured in such a manner that, when at least one of the jam removal door 401 and the take-out door 52 is opened before start, it is informed by a warning, and after the user closes the jam removal door 401 or the take-out door 52, and detects that each of doors is closed, by the jam removal door open-close sensor 405 and the take-out door open-close sensor 502, the image formation mode can be selected. Further, it is described in such a manner that the certification is conducted by using the fingerprint information, however, the certification by the password or IC card may also be allowed.

Initially, the user (the operator) selects the image formation modes by using the operation display section 8. In the image formation modes, there are a normal mode when the normal image formation is conducted, and a security mode when the image formation of the confidential document is conducted, and either one of them is selected, and when received the selection, the control section 5 sets the image formation mode (step S101 in FIG. 5. Hereinafter, it is written as S101 in abbreviation. Further, it is also the same in other steps.) Further, the confidential document means, for example, a document concerning to a trade secret, and it is controlled as a secret, and the information from the viewpoint of the useful engineering or the trade, and the information concerning to one which is not openly known. Hereupon, even if the information itself is openly known, when it is not preferable that it is openly known that the information is possessed or an interest for the information is owned, there is a case where it is managed as the confidential document, and also in the present example, that does not depart from this example.

Herein, referring to FIG. 6, a case where the image formation mode is set to the normal mode, will be described. The user places, for example, a document S on a document placement table 101 and conducts the image reading of the document, and makes the printing job, or reads out the printing job data stored in the memory section 3, and starts the printing job execution (S201). Needless to say, it is assumed that the printing job data of the confidential document stored in the memory section 3 can not be made accessible to in the normal mode.

When the sheet jam is not occurred (S202: No) and all of the image formation are completed (S203: Yes), the user takes out the outputted document. In this case, when the take-out door 52 stands opened, it is reported by warning, and the user closes the take-out door 52, and after it is detected that the door is closed, by the take-out door open-close sensor 502, it is ended.

On the one hand, when the sheet jam is occurred (S202: Yes), the user opens the jam removal door 401 or the take-out door 52 and the jam is removed, the jam sensor 406 detects that there is no transfer sheet on the conveying path (S205: Yes), and after it is detected (S206: Yes) by the jam removal door open-close sensor 405 and the take-out door open-close sensor 502 that each door is closed, the printing job is restarted.

Referring again to FIG. 5, a case where the image formation mode is set to the security mode, will be described below. When the image formation mode is set to the security mode, for example, it is displayed on the operation display section 8 that the certification is conducted, and when the user presses his finger on the window of fingerprint information reading section 4, the fingerprint information reading section 4 reads the fingerprint information of the user, and the certification module 7 compares it to the certification information stored in the memory section 3, and when it is the same as that information, it is certified (S102: Yes), and the sequence shifts to S103 (in this user certification procedure, the subsequent user certification is also conducted). On the one hand, when it is not certified (S102: No), the sequence is ended. In S103, the jam removal door lock member 403 and the take-out door lock member 501 are locked. Then, the user places the document S, for example, on the document placement table 101, and conducts the image reading of the document, and makes the printing job, or reads out the printing job data stored in the memory section 3, and starts the printing job execution (S104). Needless to say, to the printing job data of the confidential document stored in the memory section 3, the user can be made accessible in the security mode.

When the sheet jam is not occurred (S105: No) and all of the image formation are completed (S106: Yes), the user conducts the certification, and when it is certified (S107: Yes), the user releases the lock of the take-out door lock member 501 (S108), and opens the take-out door 52 and takes out the outputted document. In this case, when the take-out door 52 is kept opened, it is reported by warning, and after the user closes the take-out door 52, and it is detected by the take-out door open-close sensor 52 that the door is closed (S109: Yes), the sequence is ended. When the user is not certified (S107: No), the lock of the take-out door lock member 501 is kept as it is.

On the one hand, the sheet jam is occurred (S105: Yes), it is displayed, for example, on the operation display section 8 that the certification is to be conducted. When the user or the operator who would removes the jam presses his finger on the window of the fingerprint information reading section 4, the fingerprint information reading section 4 reads the fingerprint information of the user, and the certification module 7 compares the read-out fingerprint information to the certification information stored in the memory section 3, and when he is a jam removal permission user, he is certified (S110: Yes), and the lock of the jam removal door lock member 403 or the take-out door lock member 501 is released (S111), and after the user opens the jam removal door 401 or the take-out door 52 and removes the jam, and the jam sensor 406 detects the there is no transfer sheet on the conveying path (S112: Yes), and it is detected that each door is closed, by the jam removal door open-close sensor 405, and the take-out door open-close sensor 502 (S113: Yes), the jam removal door lock member 403 and the take-out door lock member 501 are locked (S114), and the printing job is restarted. On the other hand, when the user or the operator is not certified in S110, the jam removal door lock member 403, and the take-out door lock member 501 are kept locked, and the jam removal can not be conducted. Accordingly, there is no case where the confidential document is caught by third person's eyes.

Further, in the above description, the description is made in such a manner that, by the certification when the sheet jam is generated, the locks of the jam removal door lock member 403 and the take-out door lock member 501 are released, however, it is possible that the position in the conveying path of the transfer sheet P which causes the sheet jam, is found from the position of the jam sensor 406 which detects the sheet jam, and depending on the position in the conveying path of the transfer sheet P, only the lock of the jam removal door lock member 403 is released, and the lock of the take-out door lock member 501 is kept as it is, or only the lock of the take-out door lock member 501 is released, and the lock of the jam removal door lock member 403 is kept as it is.

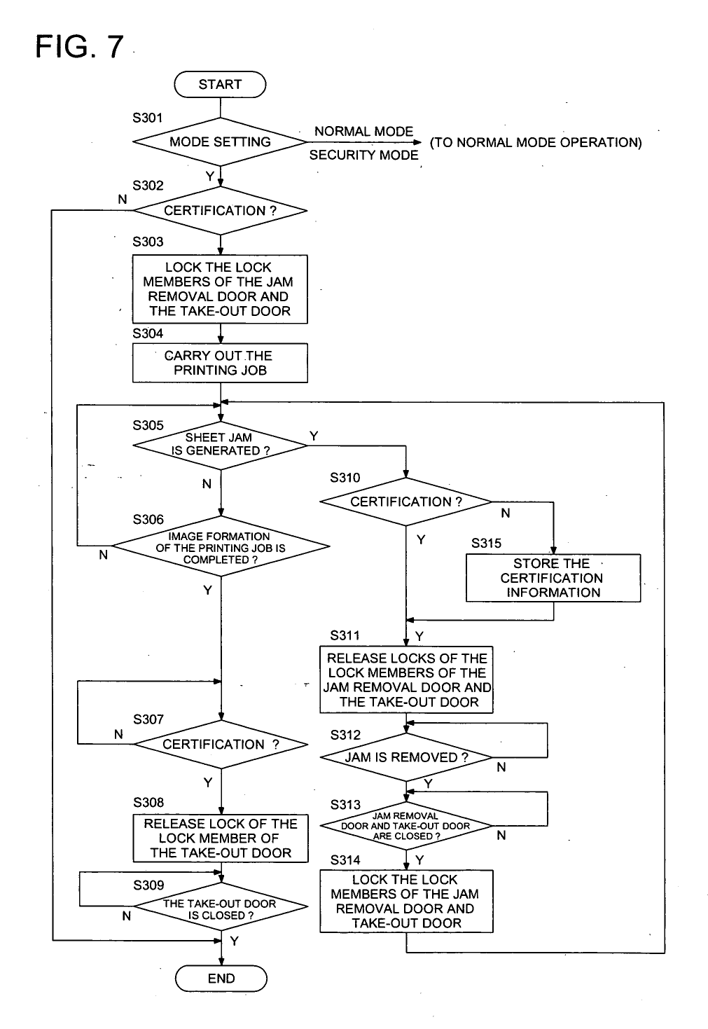

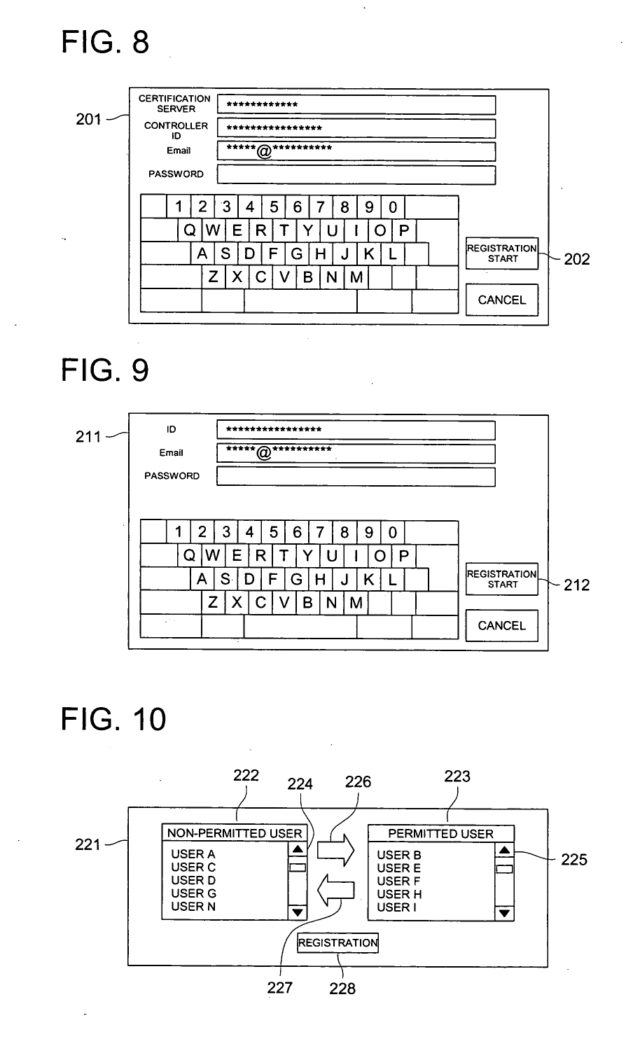

Further, when not certified in S110 in FIG. 5, it may also be allowable that the processing which will be described below, shown in FIG. 7, is conducted. FIG. 7 is a flowchart showing an example of the procedure of the printing job execution and the jam processing.

Steps S301 to S314 in FIG. 7 are the same processing as S101 to S114 in FIG. 5, however, the processing when S310 is No, is different from the processing when S110 in FIG. 5 is No. Accordingly, for the step whose content is the same, the detailed description will be omitted, and only the different part will be described. In FIG. 5, when not certified in S110, the locks of the jam removal door lock member 403 and the take-out door lock member 501 are kept locked, however, in FIG. 7, it is structured in such a manner that, when not certified in S310, the uncertified fingerprint information is stored together with a log information (for example, the jam occurrence time or a name of the printing job) of the apparatus (S315), and the sequence shifts to S311, and the locks of the jam removal door lock member 403 and the take-out door lock member 501 are released. Further, in this case, it may also be structured in such a manner that the living body information as at least the fingerprint information is stored, further, in addition to it, the other personal information is stored. In this manner, the jam removal of the security mode can be controlled.

Further, a case where the jam removal door lock member 403 and the take-out door lock member 501 are made from the lock state to the lock release state, by the certification, is described, however, in the case of the security mode, when the document in which, as described above, the door is automatically locked and which is outputted, is taken out, or the jam is removed, the lock of the jam removal door lock member 403 or the take-out door lock member 501 may be mechanically released by the key. In this case, when the key is controlled, the take-out of the outputted document or the jam removal can be controlled.

Further, in the above description, a case where the jam removal door lock member 403 and the take-out door lock member 501 are provided, is described, however, as the delivery sheet tray on which the outputted transfer sheet is only stacked in place of the transfer sheet delivery sheet section 50, only the jam removal door 401 may also be locked or lock-released as described above. Alternatively, only the take-out door 52 of the transfer sheet delivery sheet section 50 may also be locked or lock-released as described above.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. An image forming apparatus comprising:
a door for allowing a user to access to a sheet path of the image forming apparatus to recover from a sheet jam;
a lock for locking the door;
an input unit for inputting information about a user; and
a controller for controlling the lock to unlock the door in a case where the information about the user is recognized.

2. The image forming apparatus of claim 1, wherein the input unit comprises a fingerprint recognition unit from which living body information of the user is inputted.

3. The image forming apparatus of claim 1, wherein a password is inputted from the input unit.

4. The image forming apparatus of claim 1, wherein the input unit comprises a card reader from which the user information recorded on a card is read.

5. An image forming apparatus comprising:
a door for allowing a user to access to a sheet path of the image forming apparatus to recover from a sheet jam;
a lock for locking the door;
a controller for locking the door while the image forming apparatus is set in a first mode, and for unlocking the door while the image forming apparatus is set in a second mode.

6. The image forming apparatus of claim 5, further comprising:
an input unit for inputting information about a user,
wherein, in the first mode, the controller controls the lock to unlock the door in a case where the information about the user is recognized.

7. The image forming apparatus of claim 6, wherein the input unit comprises a fingerprint recognition unit from which living body information of the user is inputted.

8. The image forming apparatus of claim 6, wherein a password is inputted from the input unit.

9. The image forming apparatus of claim 6, wherein the input unit comprises a card reader from which the user information recorded on a card is read.

10. An image forming apparatus comprising:
a door for allowing a user to access to a sheet path of the image forming apparatus to recover from a sheet jam;
a lock for locking the door;
an input unit for inputting information about a user; and
a controller for controlling the lock to lock the door unless the information about the user is recognized.

11. The image forming apparatus of claim 10, wherein the image forming apparatus is capable of being selectively set in a first mode and a second mode, and wherein, in the first mode, the controller controls the lock to lock the door unless the information about the user is recognized.

12. The image forming apparatus of claim 11, wherein, in the second mode, the controller controls the lock to unlock the door regardless of the recognition of the information about the user.

13. The image forming apparatus of claim 10, wherein the input unit comprises a fingerprint recognition unit from which living body information of the user is inputted.

14. The image forming apparatus of claim 10, wherein a password is inputted from the input unit.

15. The image forming apparatus of claim 10, wherein the input unit comprises a card reader from which the user information recorded on a card is read.

16. An image forming apparatus comprising:
a first door for allowing a user to access to a sheet on which an image has been or is being formed;
a sensor for sensing a sheet jam;
a lock for locking the door;
an input unit for inputting information about a user; and
a controller for controlling the first lock to unlock the door in a case where the sheet jam is detected by the sensor and the information about the user is recognized.

17. The image forming apparatus of claim 16, wherein the input unit comprises a fingerprint recognition unit from which living body information of the user is inputted.

18. The image forming apparatus of claim 16, wherein a password is inputted from the input unit.

19. The image forming apparatus of claim 16, wherein the input unit comprises a card reader from which the user information recorded on a card is read.

20. An image forming apparatus comprising:
a first door for allowing a user to access to a sheet on which an image has been or is being formed;
a sensor for sensing a sheet jam;
a lock for locking the door;
an input unit for inputting information about a user; and
a controller, when the sheet jam has been detected by the sensor, for controlling the first lock to lock the door unless the information about the user is recognized.

21. The image forming apparatus of claim 20, wherein the input unit comprises a fingerprint recognition unit from which living body information of the user is inputted.

22. The image forming apparatus of claim 20, wherein a password is inputted from the input unit.

23. The image forming apparatus of claim 20, wherein the input unit comprises a card reader from which the user information recorded on a card is read.
